(19) United States
(12) Patent Application Publication
(10) Pub. No.: US 2016/0338390 A1
(43) Pub. Date: Nov. 24, 2016

(54) READY TO DRINK BEVERAGES WITH FOAM FORMED BY MICROWAVE ENERGY

(71) Applicant: Alexander Sher, Dublin, OH (US)

(72) Inventor: Alexander Sher, Dublin, OH (US)

(21) Appl. No.: 14/898,917

(22) PCT Filed: Jun. 19, 2013
(86) PCT No.: PCT/US13/46607

§ 371 Date: Dec. 16, 2015

(51) Int. Cl. A23L 2/54; A23L 5/30; A23L 2/46; A23F 5/24

(52) U.S. Cl. CPC A23L 2/54; A23F 5/243; A23L 5/34; A23L 2/46; A23V 2002/00

(57) ABSTRACT

Ready to drink (“RTD”) beverages are provided that have improved texture and mouthfeel, and a foam layer formed by microwaving the beverage. The RTD beverage does not have significant foam or does not have any foam when the beverage is at room temperature or lower or when poured at room temperature or lower. The RTD beverage forms a foam layer when heated prior to consumption as a hot beverage, such as by heating in a microwave oven. The beverage contains nitrous oxide (N₂O) and/or another suitable gas filled at low temperatures, such as temperatures from 2 to 6° C. for example, to dissolve in the RTD beverage. To extend shelf life of the RTD beverages, after gassing the RTD beverages can be subjected to pasteurization or sterilization techniques. The beverages preferably are coffee beverages, such as cappuccinos or espressos.

### BACKGROUND

The present disclosure generally relates to food and beverages. More specifically, the present disclosure relates to ready to drink (“RTD”) beverages having a foam layer formed by microwaving the beverage and also relates to methods for making same.

Product appearance and pleasure during consumption are key attributes driving consumer preferences all around the world. Thick, dense and stable foam is considered a highly desirable attribute for beverages such as espresso coffees or for cappuccino- or frappe-style coffee and milk beverages. Consumers drinking foamed beverages enjoy the additional aesthetic and taste characteristics that accompany beverages having a foamed topping. However, providing foamed products in a ready-to-drink (“RTD”) form is difficult. Foamed beverages such as a cappuccino or frappe for which a consumer can enjoy a nice foam head are typically prepared using a foam-generating apparatus with an external energy input, such as by whipping, gas sparging or other mechanical means of foam creation. As a result, specialized whipping/foaming equipment is required. Another existing solution is a self-foaming powder that develops a crema/foam on reconstitution, but this solution is not applicable to a ready to drink beverage. Moreover, There is a need to improve creamy texture/mouthfeel of the RTD beverages.

There are currently no liquid drinks available in the retail market that can provide a hot espresso- or cappuccino-type beverage experience in a ready to drink form.

### SUMMARY

The present disclosure provides ready to drink (“RTD”) beverages having superior texture and mouthfeel and a foam layer formed by heating the beverage and also provides methods for making same. The beverage can be a foamed coffee beverage such as a cappuccino, a latte or an espresso, but can also be other foamed beverages such as a hot chocolate, a foamed tea, a foamed fruit drink or another type of foamed beverage.

In a general embodiment, a ready to drink beverage is provided. The beverage includes a gas dissolved in the beverage, the beverage does not have significant foam when the beverage is at room temperature or lower or when the beverage is poured at room temperature or lower, and the beverage forms a foam layer when heated with microwave energy. In addition, the beverage has improved texture and mouthfeel at low and high temperatures.

In a related embodiment, the gas is nitrous oxide (N₂O).

In a related embodiment, the ready to drink beverage forms the foam layer when heated to at least 60° C.

In a related embodiment, the beverage includes coffee. The ready to drink can be selected from the group consisting of a cappuccino, a latte and an espresso.

In another embodiment, a method of providing a ready to drink beverage is provided. The method includes: dissolving N₂O gas in the ready to drink beverage; and enclosing in a container the ready to drink beverage comprising the dissolved N₂O gas, the beverage does not have significant foam when the beverage is at room temperature or lower or when the beverage is poured at room temperature or lower, and the beverage forms a foam layer when heated with microwave energy.

In a related embodiment, the N₂O gas is dissolved in the ready to drink beverage at temperatures from 2 to 6° C.

In a related embodiment, the method includes subjecting the beverage to a treatment selected from the group consisting of pasteurization, sterilization and a combination thereof, after dissolving the N₂O gas in the beverage.

In a related embodiment, the container is a flexible pouch, can, glass or plastic bottle.

In a related embodiment, the beverage comprises coffee.

In another embodiment, a method of making a beverage is provided. The method includes heating, with microwave energy, a ready to drink beverage comprising a gas dissolved in the ready to drink beverage, the ready to drink beverage does not have significant foam when the beverage is at room temperature or lower or when the ready to drink beverage is poured at room temperature or lower, and the ready to drink beverage forms a foam layer when heated with the microwave energy.

In a related embodiment, the microwave energy is based on a frequency of 2450 MHz.

In a related embodiment, the heating comprises heating the beverage to at least 60° C.

In a related embodiment, the ready to drink beverage comprises coffee.

In another embodiment, a beverage is provided. The beverage foam is formed by heating, with microwave energy, a ready to drink beverage comprising nitrous oxide dissolved in the ready to drink beverage, the ready to drink beverage does not have significant foam when the ready to drink beverage is at room temperature or lower or when the ready to drink beverage is poured at room temperature or lower, and the ready to drink beverage forms a foam layer when heated with the microwave energy.

An advantage of the present disclosure is to provide a ready to drink beverage with improved texture and mothfeel having a foam layer formed by microwaving.

Another advantage of the present disclosure is to provide a ready to drink beverage that does not have significant foam or does not have any foam at room temperature or lower or when poured at room temperature or lower. Still another advantage of the present disclosure is to provide a foam layer having superior quality relative to foam formed by a self-foaming powder.

Yet another advantage of the present disclosure is to provide a RTD beverage that forms a foam layer without whipping/foaming equipment.

Another advantage of the present disclosure is to provide a RTD beverage in which the foam layer is generated at the time of consumption using dissolved N₂O.

Still another advantage of the present disclosure is to provide a ready to drink beverage having a foam layer formed by heating to a consumption temperature.

Yet another advantage of the present disclosure is to provide a ready to drink beverage having a foam layer and easily made in the home or at work.

Another advantage of the present disclosure is to provide a hot ready to drink espresso- or cappuccino-type beverage.

Still another advantage of the present disclosure is to not only provide required foam volume after microwaving but also significantly improve beverage texture, smoothness and mouthfeel at refrigeration and temperature of consumption.

Yet another advantage of the present disclosure is to use affordable containers to provide a RTD beverage capable of generating a foam layer to consumers.

Additional features and advantages are described herein, and will be apparent from, the following Detailed Description.

### BRIEF DESCRIPTION OF THE FIGURES

FIG. 1 shows a photograph from above of a RTD beverage according to the present disclosure after microwaving.

FIG. 2 shows a photograph from the side of the RTD beverage shown in FIG. 1.

FIG. 3 shows a photograph from above of a RTD beverage according to the present disclosure after microwaving.

FIG. 4 shows a photograph from the side of the RTD beverage shown in FIG. 3.

### DETAILED DESCRIPTION

All percentages expressed herein are by weight of the total weight of the composition unless expressed otherwise. When reference is made to the pH, values correspond to pH measured at 25° C. with standard equipment. As used in this disclosure and the appended claims, the singular forms “a,” “an” and “the” include plural referents unless the context clearly dictates otherwise. As used herein, “about” is understood to refer to numbers in a range of numerals. Moreover, all numerical ranges herein should be understood to include all integer, whole or fractions, within the range.

As used herein, “comprising,” “including” and “containing” are inclusive or open-ended terms that do not exclude additional, unrecited elements or method steps. However, the beverages provided by the present disclosure may lack any element that is not specifically disclosed herein. Thus, any embodiment defined herein using the term “comprising” also includes embodiments “consisting essentially of” and “consisting of” the disclosed components.

The present disclosure relates to ready to drink (“RTD”) beverages having foam formed by microwaving the beverage. “Ready-to-drink beverage” means a beverage in liquid form that can be consumed without the further addition of liquid. The RTD beverages are stored and distributed under refrigeration temperatures and/or ambient temperatures. The RTD beverage does not have significant foam when the beverage is at room temperature or lower or when poured at room temperature or lower; however, the RTD beverage forms a foam layer when energy in microwave region of electromagnetic spectra is applied is , such as prior to consumption as a hot beverage. In an embodiment, the RTD beverage does not have any foam when the beverage is at room temperature or lower or when poured at room temperature or lower. “Room temperature” means about 25° C. The beverage contains nitrous oxide (N₂O) and/or another suitable gas filled at low temperatures, such at temperatures from 2 to 6° C. for example, to dissolve in the RTD beverage.

The gassing can be performed at any stage of the beverage production process. The gas may be injected into the beverage in any suitable way, e.g. by sparging the gas into the beverage through a nozzle designed to form small bubbles. In a preferred embodiment, the beverage is subjected to saturation pressure during and/or after the injection of the gas, e.g. to a pressure between 1.2 and 2.0 bar, preferably between 1.5 and 1.8 bar. The pressure may be created by conveying the beverage through a high pressure pump, and the gas can be injected into the beverage before and/or after the high pressure pump. The gas injection may be performed in a way so that the gas is entirely solubilized in the beverage, or the gas may be present in the beverage as gas bubbles, e.g. with a size of 1 to 10 microns.

To extend shelf life of the RTD beverages, after gassing the RTD beverages can be subjected to pasteurization or sterilization techniques (e.g. UHT, retorting). For example, a UHT treatment is ultra-high temperature processing or an ultra-heat treatment involving at least partial sterilization of a composition by heating it for a short time, around 1-10 seconds, at a temperature exceeding 135° C. There are two main types of UHT systems: the direct and indirect systems. In the direct system, products are treated by steam injection or steam infusion, whereas in the indirect system, products are heat treated using plate heat exchanger, tubular heat exchanger or scraped surface heat exchanger. Combinations of UHT systems may be applied at any step or at multiple steps in the process of beverage preparation.

A HTST treatment (High Temperature/Short Time) is a pasteurization method using a temperature of at least 71.7° C. for 15 to 20 seconds. Flash pasteurization is a method of heat pasteurization of perishable beverages prior to filling into containers to kill spoilage micro-organisms, make the beverages safer and extend their shelf life. The liquid moves in controlled continuous flow while subjected to temperatures of 71.5° C. to 74° C. for about 15 to 30 seconds. Retorting typically is treatment for 5 to 35 minutes at 121 to 125° C. Any of these pasteurization or sterilization techniques or any other suitable techniques may be used after gassing the RTD beverage, and a combination of treatments can be used.

Plastic, metal or glass bottles and cans can be used as containers for the RTD beverages. In an embodiment, the container can be microwavable such that microwave heating does not damage the container. The container can contain one or two servings of the RTD beverage, although larger containers can be used, for example so that the consumer can transfer a desired amount of the beverage to another container before microwaving. In an embodiment, the RTD beverage is packaged in a flexible pouch opened by the consumer, then the RTD beverage is transferred to a microwavable container such as a mug, a drinking glass or the like, and then heating in a microwave obtains a high quality foamed RTD beverage.

The RTD beverages do not produce any significant level of foam from pouring at cold or room temperatures. The RTD beverages form a top foam layer when heated with microwave energy, such as microwaving the beverage to consumption temperatures, for example about 60 to about 90° C. For example, the RTD beverages are preferably heated in conditions provided by a conventional microwave oven that uses 2450 MHz frequencies. The volume of the foam layer can be varied as desired while providing superior foam texture.

The beverage can comprise at least one of coffee, leaf tea, cocoa, or fruit flavor. A preferred embodiment of the beverage comprises coffee. Non-limiting examples of types of leaf tea include green tea, black tea, white tea, oolong tea, rooibos tea, chai tea, flavored tea, herbal tea, fruit tea, and combinations thereof “Leaf tea” refers to brewable tea and optionally other ingredients in any form such as complete, cut or chiseled leaves; small fragments of leaves; powder; dust; and combinations thereof. The tea can include the tea of a single tea variety or a mixture of one or more tea varieties. The tea can be caffeinated or decaffeinated.

In an embodiment, the beverage can comprise one or more natural cocoas, alkalized cocoas, or other cocoa or chocolate based products. In an embodiment, the beverage can comprise a fruit flavor component that may include one or more fruit juices, soluble fruit powders, fruit extracts, fruit concentrates, fruit flavor crystals, fruit flavored powders, and the like. The fruit or fruit flavor may be apple, orange, pear, peach, strawberry, banana, cherry, pineapple, kiwi, grape, blueberry, raspberry, mango, guava, cranberry, blackberry or combinations thereof

In an embodiment, the beverage can comprise a dairy component that can include one or more dairy ingredients or dairy substitute ingredients. For example, the dairy ingredients can be milk, milk fat, milk powder, skim milk, milk proteins and combinations thereof. Examples of suitable dairy proteins are casein, caseinate, casein hydrolysate, whey, whey hydrolysate, whey concentrate, whey isolate, milk protein concentrate, milk protein isolate, and combinations thereof. Furthermore, the dairy protein may be, for example, sweet whey, acid whey, α-lactalbumin, β-lactoglobulin, bovine serum albumin, acid casein, caseinates, α-casein, β-casein and/or γ-casein. Suitable dairy substitute ingredients include soy proteins, rice proteins and combinations thereof, for example.

### EXAMPLES

By way of example and not limitation, the following non-limiting example is illustrative of various embodiments provided by the present disclosure.

### Example 1

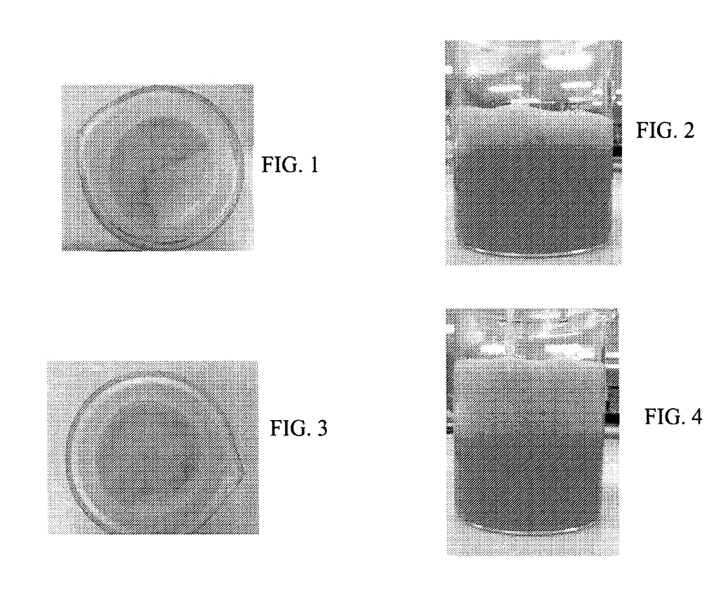

Nitrous oxide was dissolved in coffee and coffee with added milk beverages at low temperatures from 2 to 6° C. The gassed samples were filled in aluminum cans or polyethylene terephthalate (“PET”) bottles. To extend product shelf life, samples were pasteurized or retorted. Depending on filling time, temperature and product formulations, the espresso and cappuccino type beverages provided different foam volume foam volume after microwaving and also significantly improved beverage texture, smoothness and mouthfeel. See FIG. 1.

It should be understood that various changes and modifications to the presently preferred embodiments described herein will be apparent to those skilled in the art. Such changes and modifications can be made without departing from the spirit and scope of the present subject matter and without diminishing its intended advantages. It is therefore intended that such changes and modifications be covered by the appended claims.

1. A ready to drink beverage comprising a gas dissolved in the beverage, the beverage does not have significant foam when the beverage is at room temperature or lower or when the beverage is poured at room temperature or lower, and the beverage forms a foam layer when heated with microwave energy.

2. The ready to drink beverage of claim 1, wherein the gas is nitrous oxide.

3. The ready to drink beverage of claim 1, wherein the ready to drink beverage forms the foam layer when heated to at least 60° C.

4. The ready to drink beverage of claim 1, comprising coffee.

5. The ready to drink beverage of claim 1, wherein the ready to drink beverage is selected from the group consisting of a cappuccino, a latte and an espresso.

6. A method of providing a ready to drink beverage comprising the steps of:
dissolving nitrous oxide gas in the ready to drink beverage; and
enclosing in a container the ready to drink beverage comprising the dissolved nitrous oxide gas and maintaining the beverage so that the beverage does not have significant foam when the beverage is at room temperature or lower or when the beverage is poured at room temperature or lower, and the beverage forms a foam layer when heated with microwave energy.

7. The method of claim 6, wherein the nitrous oxide gas is dissolved in the ready to drink beverage at temperatures from 2 to 6° C.

8. The method of claim 6, further comprising subjecting the beverage to a treatment selected from the group consisting of pasteurization, sterilization, retorting and a combination thereof, after dissolving the nitrous oxide gas in the beverage.

9. The method of claim 6, wherein the container is selected from the group consisting of a can, bottle, flexible pouch or and any other beverage container.

10. The method of claim 6, wherein the beverage comprises coffee.

11. A method of making a beverage comprising the steps of heating, with microwave energy, a ready to drink beverage comprising a gas dissolved in the beverage, the ready to drink beverage does not have significant foam when the ready to drink beverage is at room temperature or lower or when the ready to drink beverage is poured at room temperature or lower, and the ready to drink beverage forms a foam layer when heated with the microwave energy.

12. The method of claim 11, wherein the microwave energy is based on a frequency of 2450 MHz.

13. The method of claim 11, wherein the heating comprises heating the ready to drink beverage to at least 60° C.

14. The method of claim 11, wherein the ready to drink beverage comprises coffee.

15. A beverage formed by heating, with microwave energy, a ready to drink beverage comprising nitrous oxide dissolved in the ready to drink beverage, the ready to drink beverage does not have significant foam when the ready to drink beverage is at room temperature or lower or when the ready to drink beverage is poured at room temperature or lower, and the ready to drink beverage forms a foam layer when heated with the microwave energy.
